(19) United States
(12) Patent Application Publication
(10) Pub. No.: US 2007/0185910 A1
(43) Pub. Date: Aug. 9, 2007

(54) Similar concept extraction system and similar concept extraction method utilizing graphic structure

(76) Inventors: Asako Koike, Tokyo (JP); Yoshiki Niwa, Hatoyama (JP)

Correspondence Address: REED SMITH LLP, Suite 1400, 3110 Fairview Park Drive, Falls Church, VA, 22042, US

(21) Appl. No.: 11/652,006

(22) Filed: Jan. 11, 2007

(30) Foreign Application Priority Data
Feb. 7, 2006 (JP) 2006-030037

(51) Int. Cl. G06F 17/00

(52) U.S. Cl. 707/104.1

(57) ABSTRACT

Similar concepts are deduced in consideration of relationships among concepts belonging to a plurality of categories. Concepts belonging to a plurality of categories are shown in the form of a graph in which concepts are represented by nodes and relationships between pairs of concepts are represented by edges. The number of crossings of edges linking pairs of concepts belonging to categories is reduced. Similar concepts are deduced multilaterally in consideration of the relationships between the pairs of concepts belonging to the categories.

### CLAIM OF PRIORITY

The present application claims priority from Japanese application JP-2006-030037 filed on Feb. 7, 2006, the content of which is hereby incorporated by reference into this application.

### FIELD OF THE INVENTION

The present invention relates to a system and method for graphically showing concepts and relationships among the concepts, optimizing the graphic structure under certain conditions, and thus extracting similar concepts and relationships among the concepts.

### BACKGROUND OF THE INVENTION

As one of methods for estimating similarities among concepts, there has been suggested a method of representing features of each concept with numerical values or vectors whose elements are based on other concepts, and defining the similarities in descending order of the results of the inner product operations (refer to “U-statistic Hierarchical Clustering” (D'andrade, R., 1978, Psychometrika, Vol. 4, pp. 58-67).

### SUMMARY OF THE INVENTION

The conventional method fails to take account of the similarities among elements representing features of concepts. Even if the similarities among concepts concerned are deduced after defining the similarities among elements, since the similarities among elements are predefined, the similarities cannot be defined with the relationships to concepts other than the concepts concerned relatively established.

Along with the further advancement in studies in various scholarly fields, the relationships among concepts will presumably be discussed from an unprecedented angle. Assume that medical concepts are classified into significant categories such as genes, approved drugs, and diseases. In this case, for example, as insulin is a genetic product and an approved drug, so a concept often belongs to several significant categories. Since a concept does not behave independently among the significant categories, it may be necessary not only to consider the concept in terms of a category concerned but also to estimate the similarity of concepts while taking account of the similarities of concepts relevant to the concept concerned. For example, assume that diverse physiological phenomena, diverse phenotypes, diverse partial compound structures, and diverse gene-compound interactions come to light through comprehensive analysis of genetic variations or analysis of results of experiments in which compounds are administered. If the similarities among the physiological phenomena, those among the phenotypes, or those among the genetic functions are estimated, they should be determined in consideration of correlations, for example, the relationships of the physiological phenomena to any phenotype, or the relationships of the genetic functions to any physiological phenomenon. This is because every concept has multiple aspects. Even when genes A and B are physiologically similar to each other, they may be highly probably dissimilar from each other in terms of a relevant disease. As for concepts belonging to the category of physiological functions or diseases, the similarities among the concepts are uncertain. Therefore, the relationships among the concepts that are fixed cannot be satisfactorily adopted as criteria for measuring the similarities among relevant genes.

An object of the present invention is to provide a method for estimating the similarities among concepts in consideration with the correlations among concepts belonging to other categories.

In order to overcome the foregoing drawbacks, an attribute of a concept or a highly related concept and a concept relevant to the attribute or highly related concept should be extracted. The similarity between the concepts or the relevancy to the concept is taken account in order to calculate more multifaceted similarity. According to an embodiment of the present invention, relationships among concepts are shown with a graphic structure together with the attributes of the concepts and highly relevant concepts thereof. The number of edge crossings in the graph is reduced in order to extract similar concepts. As a result of the reduction in the number of edge crossings, similar concepts are spatially disposed at close positions and become discernible. At this time, the relationships among similar concepts belonging to categories are also discernible. According to this method, not only extraction of the similarities among concepts that is a major object but also extraction of the similarities among attributes or concepts relating to the concepts can be achieved.

According to an embodiment of the present invention, after relationships among concepts are shown with a graphic structure, the number of edge crossings is reduced in order to extract similar concepts.

According to an embodiment of the present invention, a micro-array of DNAs, a micro-array of proteins, or any other groups of genes whose expressions have changed are graphically expressed in terms of a plurality of relationships among physiological functions and molecular functions, whereby the degrees of similarities among genes can be multilaterally deduced. Moreover, for example, concepts belonging to various categories such as a category of genes, a category of physiological functions, a category of biological functions, and a category of molecular functions are expressed in the form of a graphic structure. Thus, not only the similarities among genes can be extracted multilaterally but also the similarities of physiological concepts or concepts belonging to other category can be extracted at the same time. Moreover, when concepts belonging to categories of partial compound structures, compounds, genes, side effects, symptoms, and others are expressed in the form of a graphic structure, if the number of edge crossings is reduced, the similarities relative to the partial compound structures that are likely to cause side effects and the side effects can be extracted multilaterally. Moreover, the present invention is not limited to the biological or medical field. When relationships to companies, business lines, product lines, and business relations are graphically expressed, the degrees of similarities or relevancies among the companies can be multilaterally deduced.

According to an embodiment of the present invention, the similarities among concepts belonging to diverse categories can be extracted in consideration of the correlations. For example, the similarities among concepts or natures belonging to diverse categories can be estimated in consideration of the correlations. Herein, the categories refer to proteins or compounds having similar natures, similar structures among proteins or compounds having similar natures, highly-related physiological phenomena, highly-related interactions of drugs, and others.

### BRIEF DESCRIPTION OF THE DRAWINGS

FIG. 1 shows a system configuration of an example of a similar concept extraction system in accordance with the present invention;

FIG. 2 shows an example of relationships extracted by a preprocessing unit;

FIG. 3 shows an example of an input screen image supported by a data reception unit;

FIG. 4 shows an example of an input screen image supported by a plotting condition reception unit;

FIG. 5 is a flowchart describing a procedure to be followed by the system in accordance with the present invention;

FIG. 6 shows an example of entry of data in the data reception unit;

FIG. 7 shows an example of terms extracted from a database by designating categories;

FIG. 8 shows an example of a graph plotted before the number of edge crossings is reduced;

FIG. 9 shows an example of a graph plotted after the number of edge crossings is reduced;

FIG. 10 shows an example of entry of data in the plotting condition reception unit;

FIG. 11 shows an example of a graph having similar concepts highlighted with a highlight mark with the number of edge crossings reduced;

FIG. 12 shows an example of entry of data in the data reception unit;

FIG. 13 shows an example of a graph having similar concepts highlighted with a highlight mark with the number of edge crossings reduced;

FIG. 14 shows an example of terms extracted from a database by designating categories;

FIG. 15A and FIG. 15B show examples of graphs plotted after the number of edge crossings is reduced;

FIG. 16 shows an example of entry of data in the data reception unit;

FIG. 17 shows an example of a graph plotted after the number of edge crossings is reduced;

FIG. 18 shows an example of entry of data in the data reception unit;

FIG. 19 shows an example of entry of data in the plotting condition reception unit;

FIG. 20 shows an example of a graph plotted after the number of edge crossings is reduced;

FIG. 21 shows an example of entry of data in the data reception unit;

FIG. 22 shows an example of entry of data in the plotting condition reception unit; and

FIG. 23 shows an example of a graph plotted after the number of edge crossings is reduced.

### DETAILED DESCRIPTION OF THE PREFERRED EMBODIMENTS

Referring to the drawings, an embodiment of the present invention will be described below. Herein, a description will be made of a case where the present invention is applied to processing of biomedical terms. Noted is that the present invention shall not be limited to the embodiment described below.

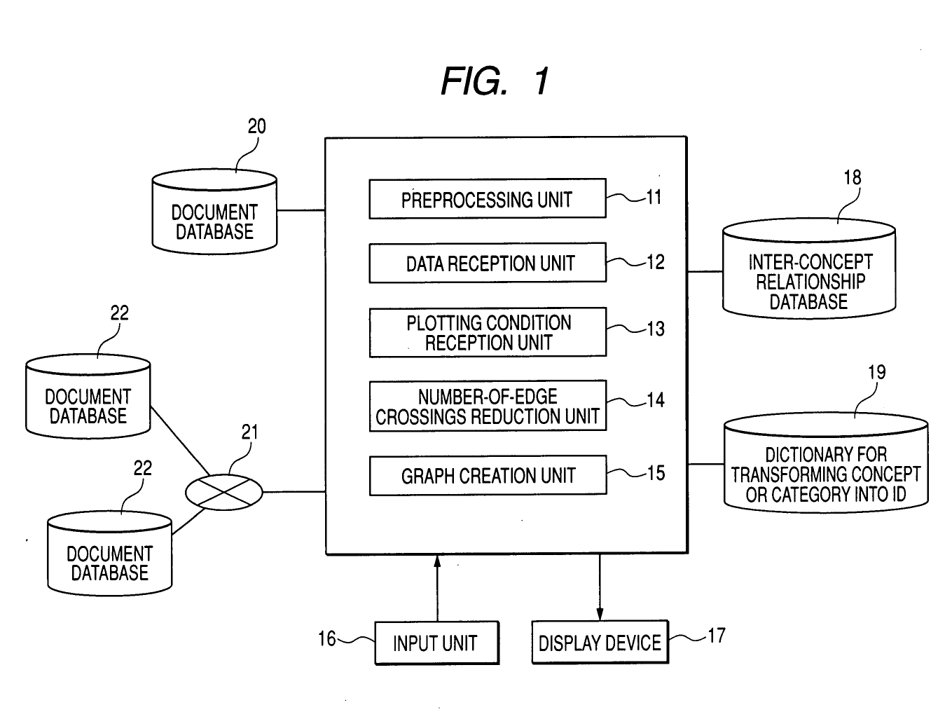

FIG. 1 shows a system configuration of an example of a similar concept extraction system in accordance with the present invention. The system includes: a preprocessing unit 11 that calculates in advance concepts represented by nodes, categories to which the concepts belong, and relationships among nodes represented by edges; a data-reception unit 12 that receives these data items; a plotting condition reception unit 13 that designates conditions for nodes or edges that are fixed in a graph, that designates conditions for weighting edges at the time of reducing the number of edge crossings or priorities to be assigned to types of edges in order to eliminate crossings, and that designates whether similar concepts should be highlighted; a number-of-edge crossings reduction unit 14 that calculates a graph having the number of edge crossings reduced under a condition designated based on received data; an input unit 16 such as a mouse and a keyboard; and a display device 17 such a CRT.

Conceivable as concepts represented by nodes or categories into which the concepts represented by the nodes are classified are compounds, diseases, symptoms, proteins or genes, physiological terms, descriptors signifying partial structures or properties of a compound or protein, foods, human beings, organizations, and projects. Any concepts can be adopted as far as they interest a user. Edges represent relationships among concepts. Each edge may express only an intensity of relevancy alone, only a type of relevancy such as activation, inhibition, equality (is-a), or inclusion (component-of), both the intensity and type of relevancy. However, the present invention is not limited to this mode.

The preprocessing unit 11 accumulates pieces of information on proteins, pieces of information on interactions between pairs of compounds, and pieces of functional information, which are extracted from literatures stored locally in a document database 20 or from text data, which is stored in a document database 22 at a Web site accessed over a network 21, manually or automatically through syntax analysis or statistical analysis. The preprocessing unit 11 also accumulates as binary relationships various relationships between pairs of concepts such as the relationships between proteins and diseases, the relationships between symptoms and diseases, and the relevancies between physiological phenomena and diseases which are extracted from the literatures or text data. Namely, the relationships between genes and biological functions or other relationships between pairs of concepts which are fetched from any local database or any database at a Web site are accumulated. As for the relationships, when the number of objects is small, pre-calculation is not needed but terms may be indexed at a preprocessing step. Thus, input data may be dynamically produced according to the necessity.

Relationships represented by edges conceivably include relevancies that are obtained statistically and have intensities, relevancies whose intensities are inferred through mechanical learning, relationships that are obtained through syntax analysis and have types and intensities (frequencies of appearance), binary relationships obtained through reading performed by a human being, and binary relationships described in various databases. However, the present invention is not limited to the relevancies and relationships. A compound may be discomposed into partial structures, and the partial structures may be represented by nodes. Edges linking the compound with the partial structures may represent relationships of inclusion (component-of). Likewise, proteins, domains constituting each protein, and a motif of the domains may be represented by nodes, and the relationships of inclusion (component-of) of each protein to the domains and motif may be represented by edges. Furthermore, the natures of the proteins and other proteins may be expressed using nodes and edges. Object literatures include not only abstracts acquired from database MEDLINE and full papers sampled from PubMed Central but also biomedical literatures including pieces of information on drugs provided by the Food and Drug Administration of the United States Department of Health and Human Services and documents appended to drugs, patent documents, various scientific literatures, trade journals, newspapers, and other documents that interest a user.

In efforts to solve a problem posed by synonyms and homonyms, names of genes or proteins, names of compounds, names of diseases acquired from database Online Mendelian Inheritance in Man (OMIM), manually controlled terminologies or dictionaries such as the Unified Medical Language System (UMLS), International: the Systematized Nomenclature of Medicine (SNOMED), and Medical Subject Headings (MeSH), or the combination thereof should preferably be used to recognize terms or concepts in advance in consideration of the spelling-related diversity of terms. Alternatively, all nouns contained in a text may be adopted as terms or concepts. Among all nouns contained in a text, only nouns whose use frequencies in corpus concerned are higher than the user frequencies thereof in newspapers or other corpus may be adopted as terms or concepts. Otherwise, pieces of mutual information on neighboring words or x²-test may be utilized or the C-value or NC-value method may be used to automatically extract a set of words from an object literature. Moreover, when terms or concepts are automatically extracted, categories (significant categories) may have to be appended to them. The categories of concepts are, for example, genes or proteins, compounds, diseases, symptoms, physiological terms, molecular functions, biological functions, or partial compound structures. In order to newly classify concepts into the categories, a thesaurus defining terms and significant categories may be used to create tagged corpus. The relationships between local contexts of terms or concepts and categories may be automatically learned through the maximum entropy method or mechanical learning to be achieved using a support vector machine or the like. In order to newly create a category, corpus accompanied by a tag signifying an answer may be created, and the mechanical learning approach or both the mechanical learning approach and boot strapping approach may be used to automatically learn the relationships between local contexts of terms or concepts and categories.

For analysis of the relationships between pairs of concepts through syntax analysis, there is a method of using a shallow parser or a full parser to extract predicate argument structures so as to search relevant structures. Moreover, methods of extracting the relationships between pairs of concepts through statistical analysis include a method utilizing dice coefficients, mutual information, or singular value decomposition. The statistical relationships between pairs of concepts may be listed in the form of a table in advance or dynamically calculated.

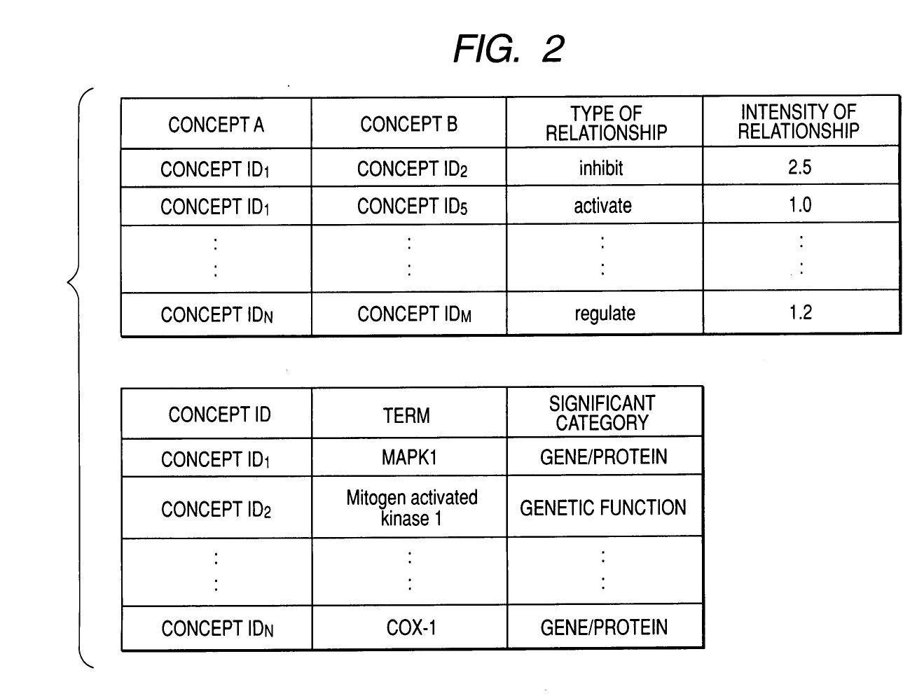

FIG. 2 shows an example of relationships extracted by the preprocessing unit 11. The relationships are distinguished by intensities and types including inhibition, activation, and others. At this time, if categories (significant categories) into which concepts belong are predefined, they are adopted. Assuming that concepts and relationships between pairs of concepts are already extracted, the preprocessing unit 11 should perform nothing. In the example shown in FIG. 2, a concept ID₁ belonging to a significant category of genes or proteins and a concept ID₂ belonging to a significant category of genetic functions have a relationship of inhibition. The intensity of the relationship is 2.5. Concepts ID and terms are associated with each other as shown in FIG. 2. If a term is entered, the term is transformed into a concept ID by referencing the table.

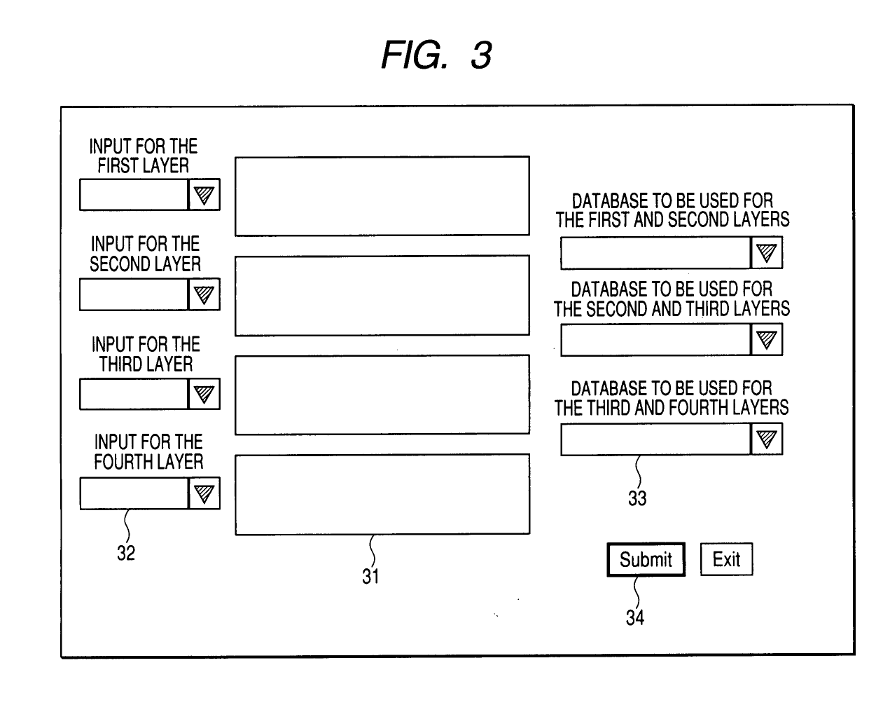

FIG. 3 shows an example of an input screen image displayed on the display device 17 by the data reception unit 12. A concept input block 31 is an input block with which terms, identifiers (IDs), or a group of categories to be used in each layer are designated. At this time, an input type selection block 32 is used to designate whether terms, IDs, or categories are entered in the concept input block 31. A database containing pieces of information on edges and nodes to be employed in each layer is designated using a database designation block 33. Consequently, if terms, IDs, or categories that are not registered in the database designated with the database designation block 33 are designated using the concept input block 31, nothing is displayed as data to be acquired over a network.

When Terms or IDs is designated in the input type selection block 32, actual terms or IDs to be assigned to a certain layer are entered in the concept input block 31. If Categories is designated in the input type selection block 32, the system searches a database designated with the database designation block 33, extracts terms belonging to categories, and adopts the terms as terms included in the layer. In the case of, for example, a three-layer graphic structure, if Categories is designated for the first layer using the input type selection block, the system searches a database designated as a database to be used for the first and second layers, and extracts terms belonging to certain categories. If Categories is designated for the second layer using the input type selection block, the system searches and extracts terms belonging to certain categories from terms contained in both the database designated as a database to be used for the first and second layers and the database designated as a database to be used for the second and third layers.

The plotting condition reception unit 13 designates such a plotting condition that a sole category or a plurality of categories is fixed for each set (layer) of concepts and concepts belonging to the other categories are made movable or that a concept concerned is fixed instead of a category or categories and the other concepts are made movable. The plotting condition reception unit 13 can fix the positions of concepts, which belong to a sole category or a plurality of specific categories, in a graph and move the positions of concepts, which belong to the other categories, for the purpose of reducing the number of edge crossings. This method makes it possible to learn the similarities among concepts, which belong to the other categories, from a certain viewpoint.

Moreover, a display form in which similar concepts are recognized under a certain condition and highlighted can be designated if necessary. For highlighting, not only cliques but also semi-cliques satisfying a certain condition are searched. As for concepts belonging to the same group or layer, even when no edge exists in reality, calculation may be performed as if edges were present. As a condition for extracting semi-cliques, a threshold may be determined for a quotient of the number of edges included in a sub-graph by the number of edges needed for a clique, a quotient of a minimum degree of a sub-graph by the degree of a clique, or a quotient of the number of nodes linked in common with nodes (belonging to the same category and contained in a sub-graph) by the number of adjacent nodes. However, the present invention is not limited to this method.

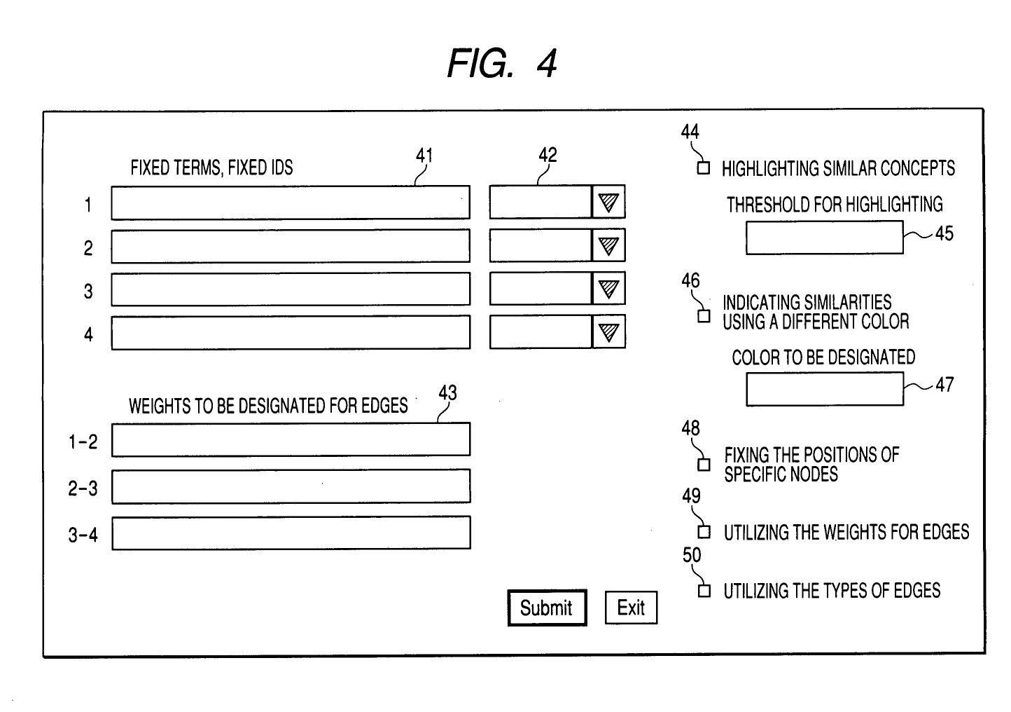

FIG. 4 shows an example of an input screen image to be displayed on the display device 17 by the plotting condition reception unit 13. A fixed information input block 41 helps designate terms or IDs to be fixed in a graph and their sequence (positional relationship). The terms or IDs entered in the fixed information input block 41 are fixed and displayed in a graph in the order in which they are entered. Otherwise, a symbol indicating the position of a term or ID in the graph may be appended to each term or ID in such a manner as ID1-1, ID2-2, ID3-3, etc. Whether an input entered in the fixed information input block 41 is an input of terms or an input of IDs is designated using an input type selection block 42. Assuming that Terms is designated in the input type selection block 42, when terms are entered in the fixed information input block 41, the system uses a dictionary 19, which helps transform concepts or categories into IDs, to internally transform the entered terms into IDs. Subsequent processing is performed using the IDs. When IDs is designated in the input type selection block 42, the system does not perform transformation into IDs.

By checking a check box 48, the fixed information entered in the screen image is utilized. Unless the check box 48 is checked, the information entered in the fixed information input block 41 is not utilized. A check box 49 is checked in a case where weights to be assigned to edges are taken account at the time of reducing the number of edge crossings. The weights are designated in a weight input block 43. A check box 50 is checked in a case where the types of edges are taken account at the time of reducing the number of edge crossings. For highlighting of similar concepts, a check box 44 is checked, and a threshold for highlighting is designated in an input box 45. For display of similarities using a different color, a check box 46 is checked, and a color is designated in an input box 47.

A graph creation unit 15 constructs an appropriate initial structure of a graph. Various techniques are conceivable as a method according to which a number-of-edge crossings reduction unit 14 reduces the number of edge crossings. For example, a bubble sort technique may be applied to each of layers orderly from a start layer to an end layer in order to reduce the number of edge crossings. Furthermore, the bubble sort technique may be applied to the layers orderly from the end layer to the start layer in order to thus minimize the number of edge crossings in an entire graph. An alternative is a statistical thermodynamic method such as the Monte Carlo method for minimizing energy of an entire graph on the assumption that a state of a graph containing crossing edges is considered as a state of a high energy level. However, the present invention is not limited to the methods. The priority for eliminating edge crossings may be differentiated according to the intensity of a relationship or the type thereof.

A number-of-edge crossings reduction unit 14 reduces the number of edge crossings under a designated condition. For reduction of the number of edge crossings which depends on a weight assigned to edges or a type of relationship such as activation or inhibition, crossings of edges assigned a higher weight may be eliminated according to priority, or crossings of different types of edges are eliminated according to priority. Either of the conditions is designated by the plotting condition reception unit 13. Furthermore, as for edges getting out of the same node other than crossing edges, the number of adjacencies between pairs of different types of edges can be reduced.

For example, assuming that nodes represent partial structures of a compound, side effects of compounds, and physiological actions, the relationships among nodes are graphically expressed. If the number of edge crossings is reduced, similarities relative to the side effects, similarities relative the partial compound structures causing the side effects, and the physiological actions shared by the partial structures can be acquired simultaneously. Techniques for discomposing a compound into partial structures or elements in advance include a compass algorithm and a finger print method. However, the present invention is not limited to the techniques.

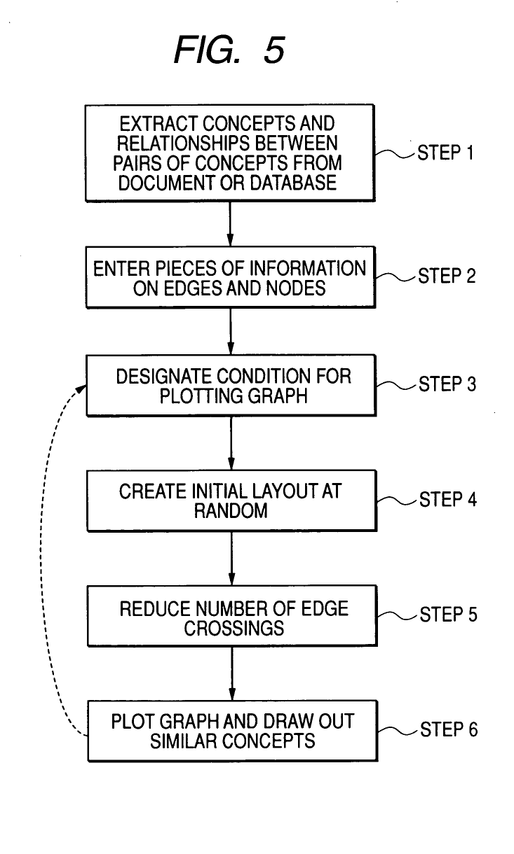

FIG. 5 is a flowchart describing a procedure to be followed by the system in accordance with the present invention. To begin with, at step 1, the preprocessing unit 11 is used to manually or automatically extract concepts and relationships between pairs of concepts from literatures or various databases. At step 2, the input unit 16 including a mouse and a keyboard is used to enter concepts and relationships between pairs of concepts in the data reception unit 12. At step 3, a plotting condition is designated in the plotting condition reception unit 13. Specifically, what concepts should be fixed or whether similar concepts are highlighted is designated. When similar concepts are highlighted, a threshold is designated. At step 4, the graph creation unit 15 generates an initial structure. At step 5, the number-of-edge crossings reduction unit 14 reduces the number of edge crossings. At step 6, the graph creation unit 15 creates a graph, and the created graph is displayed on the display device 17. Similar concepts are drawn out of the graph. After the number of edge crossings is reduced and the graph is displayed on the display device 17, the procedure may be returned to step 3. The plotting condition may be changed to another using the plotting condition reception unit 13, and a graph may be re-plotted.

Next, an example of similar concept extraction to be performed using the system in accordance with the present invention will be described in conjunction with concrete examples.

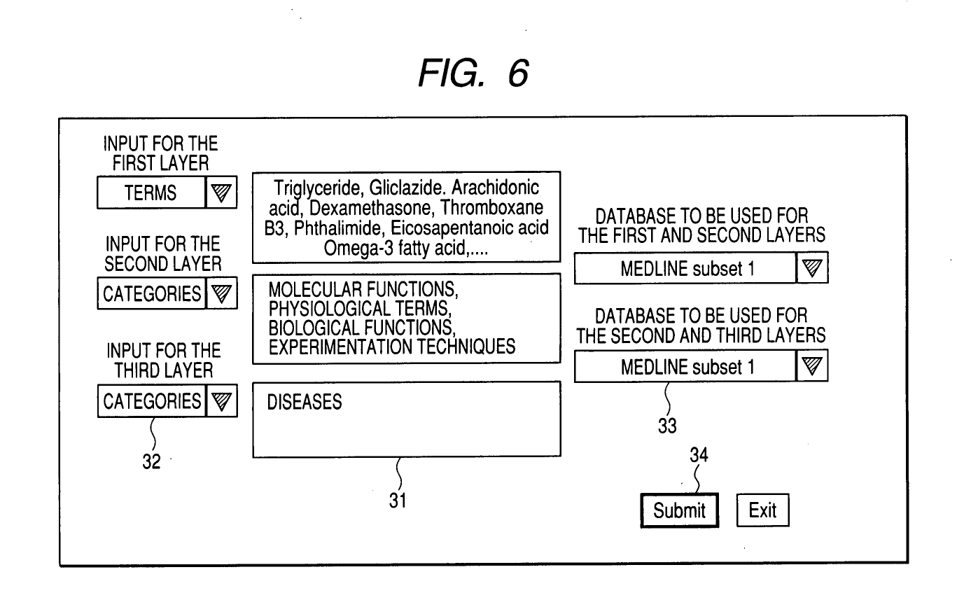

In the present embodiment, concepts to be included in three layers are, as shown in FIG. 6, entered in an input screen image supported by the data reception unit 12. Specifically, as for the concepts to be included in the first layer, Terms is designated in the input type selection block 32, and concrete terms are entered in the concept input block 31. As for the concepts to be included in the second layer, Categories is designated in the input type selection block 32, and molecular functions, physiological terms, biological functions, and experimentation techniques are entered as categories in the concept input block 31. As for the concepts to be included in the third layer, Categories is designated in the input type selection block 32, and diseases is entered as a category in the concept input block 31. As a database to be used for the first and second layers and a database to be used for the second and third layers, MEDLINE Subset 1 is designated.

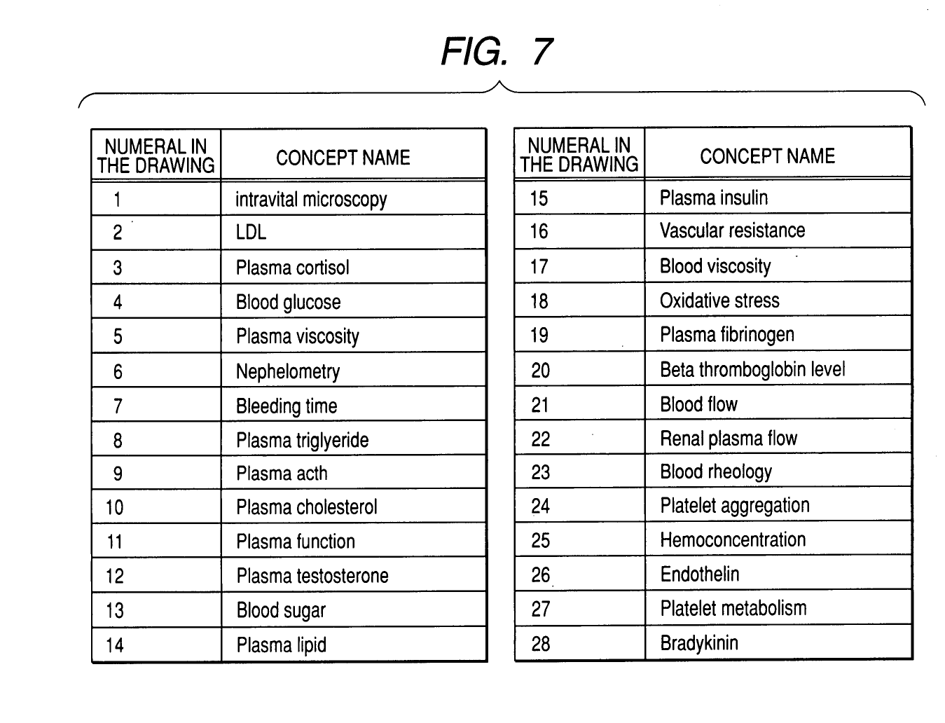

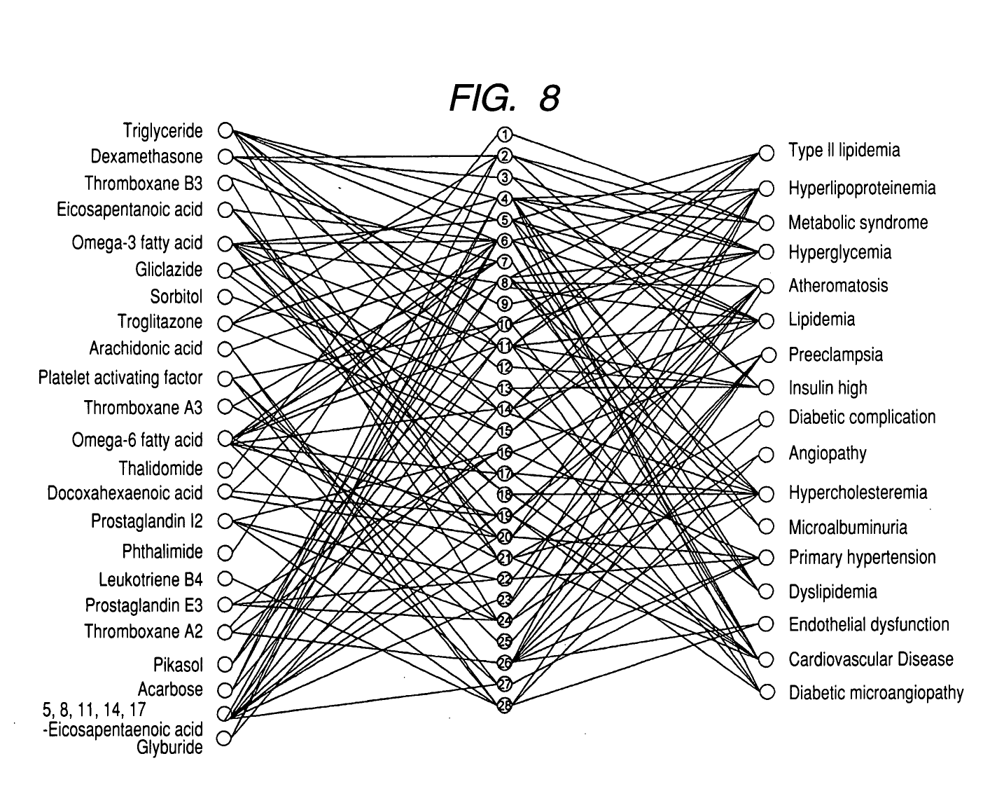

In this state, if a Submit button 34 is pressed, the data reception unit 12 extracts terms, which belong to the categories of molecular functions, physiological terms, biological functions, and experimentation techniques, from the MEDLINE Subset 1. Consequently, for example, terms shown in FIG. 7 are extracted and adopted as terms to be included in the second layer. Likewise, the data reception unit extracts terms, which belong to the category of diseases, from the MEDLINE Subset 1, and regards them as terms to be included in the third layer. Thus, for example, the terms shown in the right side of FIG. 8 are assigned to the third layer. Moreover, the data reception unit 12 extracts the relationships between the terms in the first layer and the terms in the second layer and the intensities of the relationships from the MEDLINE Subset 1. Likewise, the data reception unit 12 extracts the relationships between the terms in the second layer and the terms in the third layer and the intensities of the relationships from the MEDLINE Subset 1, and holds them as pieces of edge information.

Assume that nothing is entered in the input screen image supported by the plotting condition reception unit 13 and shown in FIG. 4. The graph creation unit 15 randomly designates an initial arrangement of terms constituting the respective layers as an initial state, and creates a graph containing edges. The thus created graphic structure in which the number of edge crossings is not reduced is displayed on the display device 17. FIG. 8 shows an example of the thud displayed graph showing the relationships among concepts. As the relevancies among concepts, relationships of co-occurrence which are detected in medical literatures and whose degrees exceed a certain threshold are adopted. The leftmost layer (first layer) is composed of concepts concerning compounds. The intermediate layer (second layer) is composed of concepts concerning molecular functions, physiological terms, biological functions, and experimentation techniques. The rightmost layer (third layer) is composed of concepts concerning diseases. Incidentally, for convenience sake, the terms in the second layer are denoted by numerals in FIG. 8 for fear the display of the terms themselves may impair the discernment of the graph. FIG. 7 shows the relationships of associations between the numerals and terms.

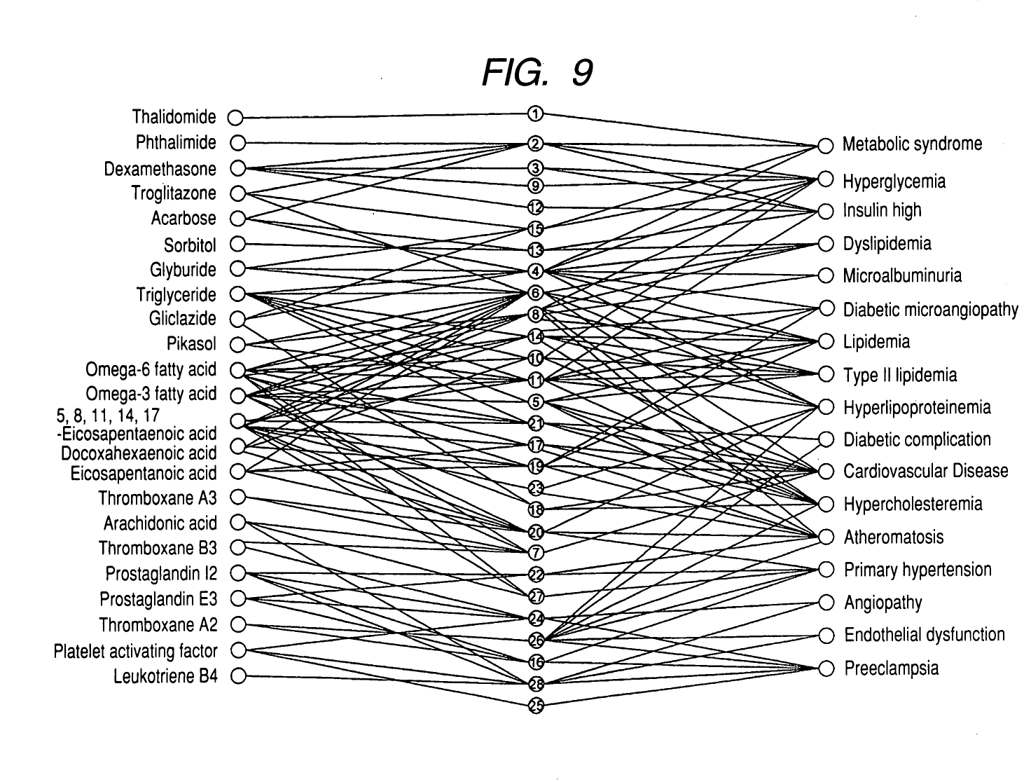

For the graph shown in FIG. 8, the number-of-edge crossings reduction unit 14 explores an arrangement having the number of edge crossings minimized by modifying the arrays of terms in the respective layers. The reduction in the number of edge crossings provides a graph in which compounds having similar functions and similar physiological concepts are, as shown in FIG. 9, shown adjacently to one another. Herein, the reduction in the number of edge crossings signifies that crossings of edges are reduced under a given condition. For example, when edges are weighted, if crossings of heavily weighted edges are eliminated, the number of edge crossings gets smaller than if crossings of lightly weighted edges are eliminated.

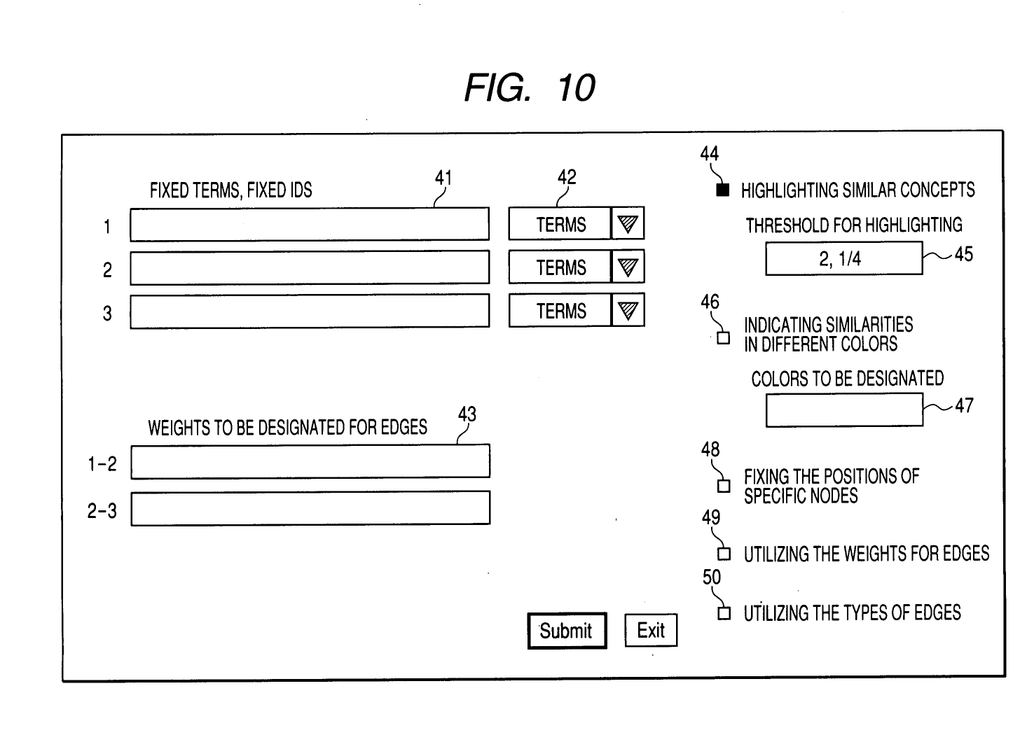

As shown in FIG. 10, highlighting is designated in an input screen image supported by the plotting condition reception unit 13. In this example, the check box 44 for use in designating highlighting is checked, and “2¼” is entered in the input block 45 for use in entering a threshold. This signifies that nodes to be highlighted share two or more other nodes and the number of shared nodes is a one-fourth or more of the number of edges terminated at each of the nodes to be highlighted.

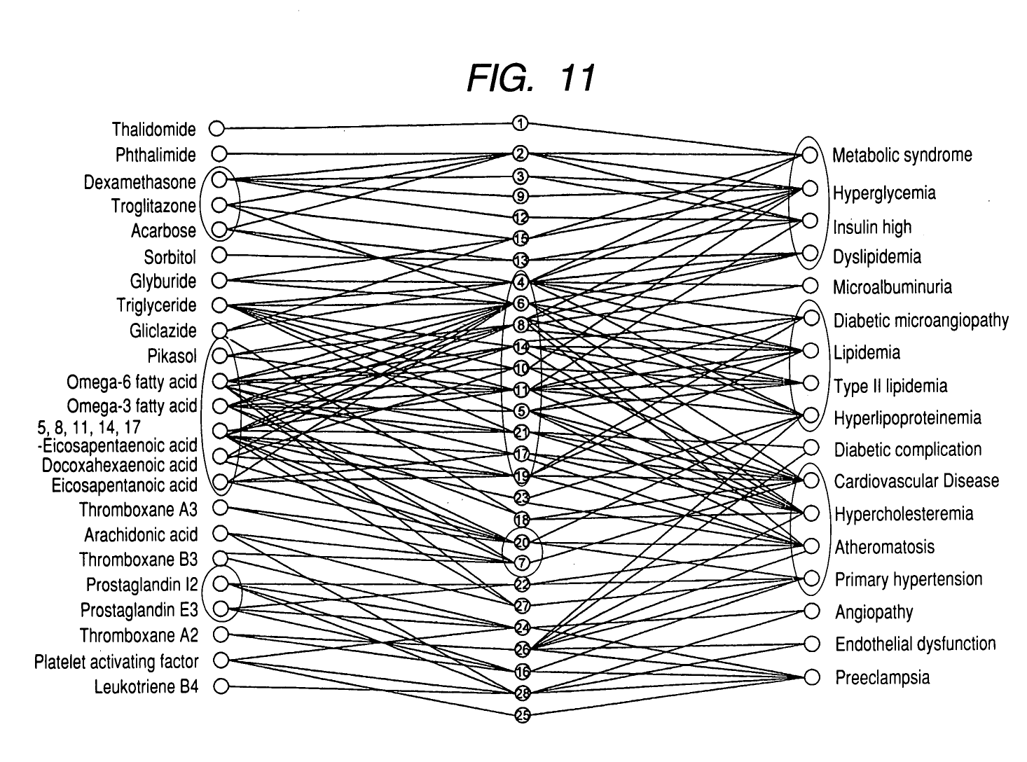

The graph creation unit 15 receives a condition for highlighting from the plotting condition reception unit 13, highlights nodes meeting the condition, and displays them on the display device. Consequently, a graph like the one shown in FIG. 11 is displayed on the display device 17. In FIG. 11, highlighting is encircling of nodes. Alternatively, a color in which the nodes are displayed may be differentiated from a color in which the other nodes are displayed. Thus, the employment of a highlighting facility makes it possible to explicitly show similar concepts or terms presumed to define similar functions.

Next, a description will be made of a case where similarities among concepts are differently recognized by changing categories adopted for a layer to be used in combination with the first layer.

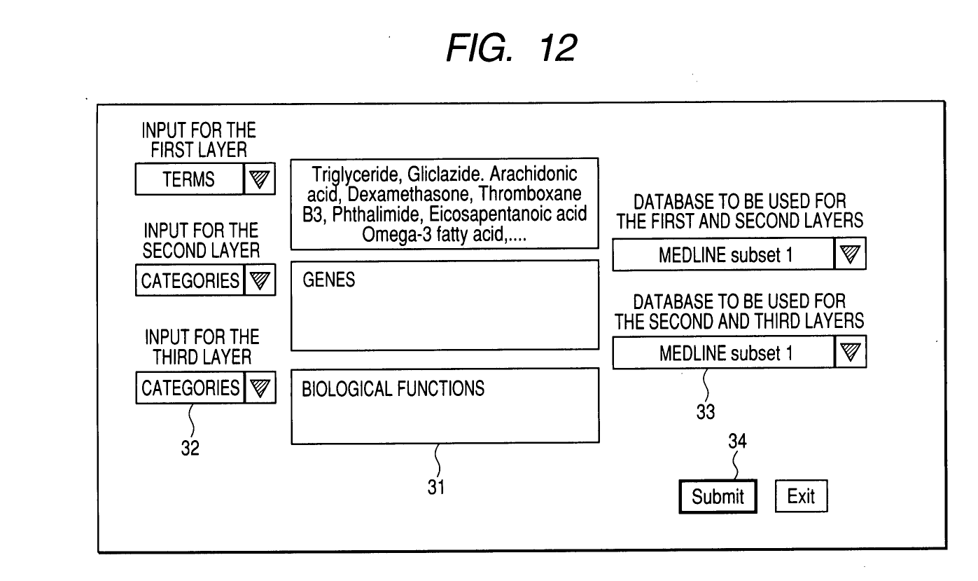

FIG. 12 shows an input screen image supported by the data reception unit 12 and employed in this example. For the first layer, concrete terms are entered as concepts concerning compounds. For the second layer, genes are designated as a category. For the third layer, biological functions are designated as a category. The terms of the compounds entered for the first layer are identical to those of the compounds in the leftmost first layer in FIG. 8. Moreover, the database to be used for the first and second layers and the database to be used for the second and third layers are the same MEDLINE Subset 1. In the input screen image supported by the plotting condition reception unit 13, similarly to that shown in FIG. 10, highlighting is designated, and “2¼” is entered as a threshold in the input box 45.

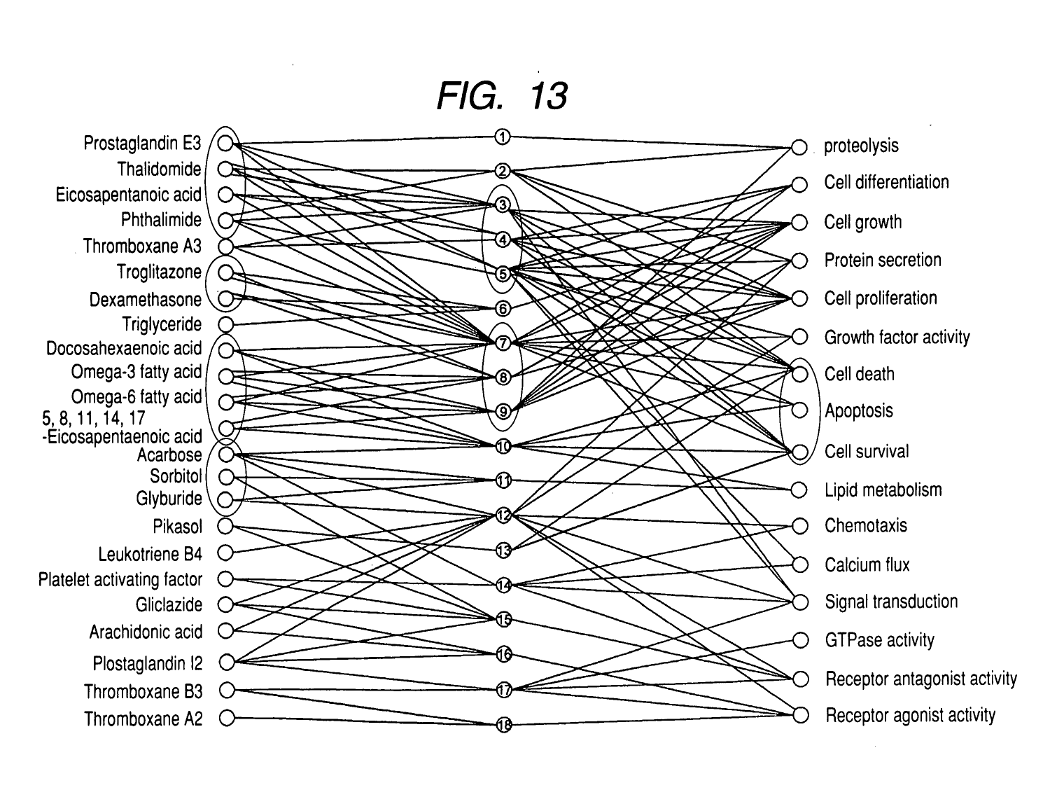

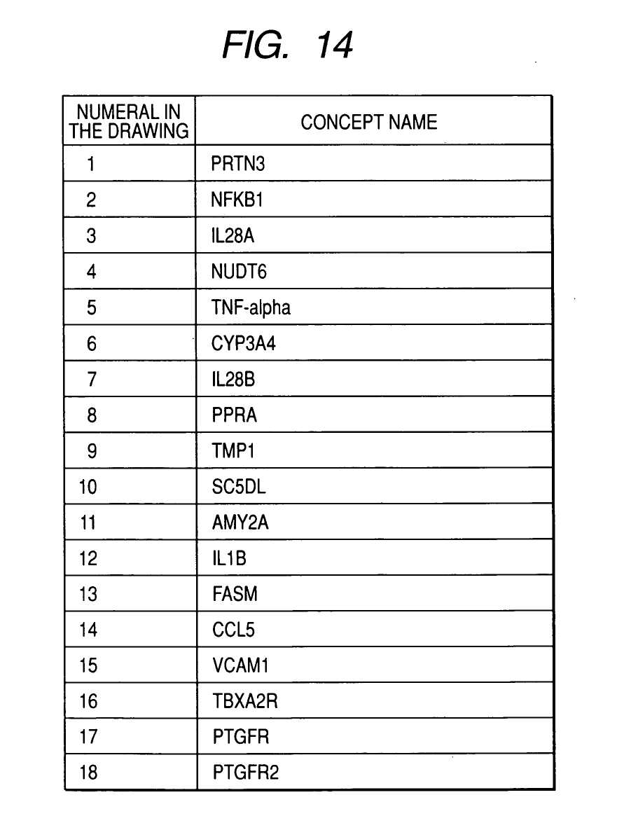

FIG. 13 shows a graph indicating the relationships among concepts and being displayed on the display device after number-of-edge crossings reduction is executed under the foregoing conditions according to an embodiment of the present invention. Terms belonging to the category of genes and being extracted from the MEDLINE Subset 1 for the second layer are denoted by numerals in FIG. 13 for fear the display of the terms themselves may impair the discernment of the graph. FIG. 14 shows the associations between the numerals and terms.

FIG. 11 and FIG. 13 are different from each other in terms of the significant categories of concepts in the intermediate layer (second layer) and those of concepts in the right layer (third layer). Consequently, the similarities of compounds (first layer) are different between the drawings. For example, as shown in FIG. 11, thalidomide, phthalimide, eicosapentaenoic acid, and prostaglandin E3 have no similarity among themselves in terms of the relevancies to molecular functions, physiological terms, biological functions, experimentation techniques, or diseases. As shown in FIG. 13, similarities are found in terms of the relevancies to the concepts of genes or the concepts of biological functions. Namely, similarities can be defined from various viewpoints. FIG. 11 and FIG. 13 give examples demonstrating that different viewpoints lead to different answers. Substances may have to be investigated in terms of their biomedical functions or may have to be investigated in terms of administration thereof to a living body. The diverse presentations of similarities have significant meanings.

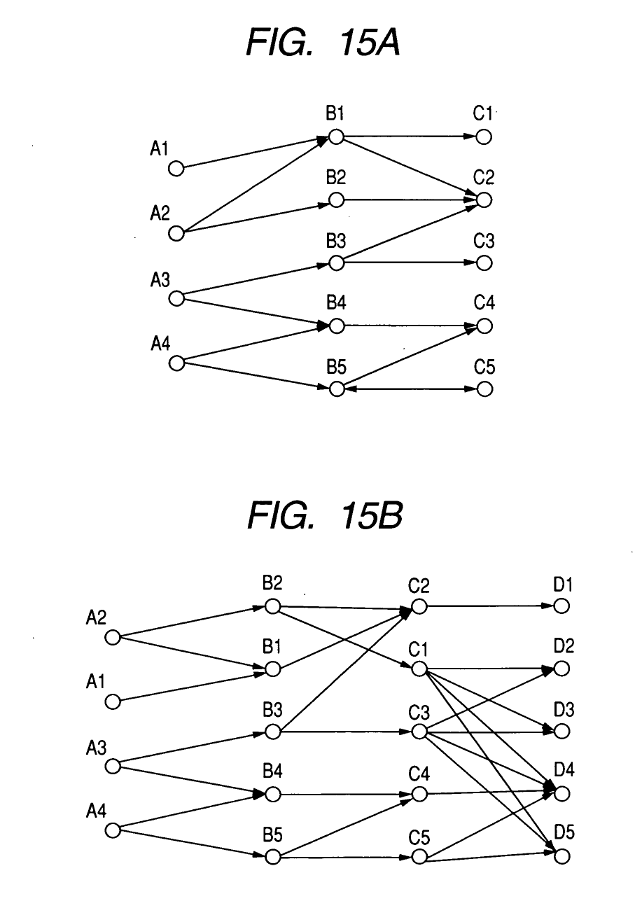

According to an embodiment of the present invention, a plurality of layers such as two, three, or four layers can be utilized. When the number of layers is increased in order to introduce a new viewpoint from which concepts are assessed, the similarities of the concepts may be recognized differently. Referring to FIG. 15, a case where recognition of similarities varies with addition of a layer will be described below.

FIG. 15A shows a graph having three layers, and FIG. 15B shows a graph having four layers. The graph shown in FIG. 15B is created by adding one layer as the fourth layer to the graph shown in FIG. 15A. Terms included in the first to third layers are identical between the two graphs. As seen from the drawings, when the number of layers increases, a new viewpoint from which concepts are assessed is introduced. Consequently, the sequence of concepts on the leftmost side may be changed. In this example, the sequences of pairs of A1 and A2, B1 and B2, and C1 and C2 are different between FIG. 15A and FIG. 15B. This is because when the concepts in the fourth layer are utilized, information signifying that C1 and C3 are close to each other is reflected.

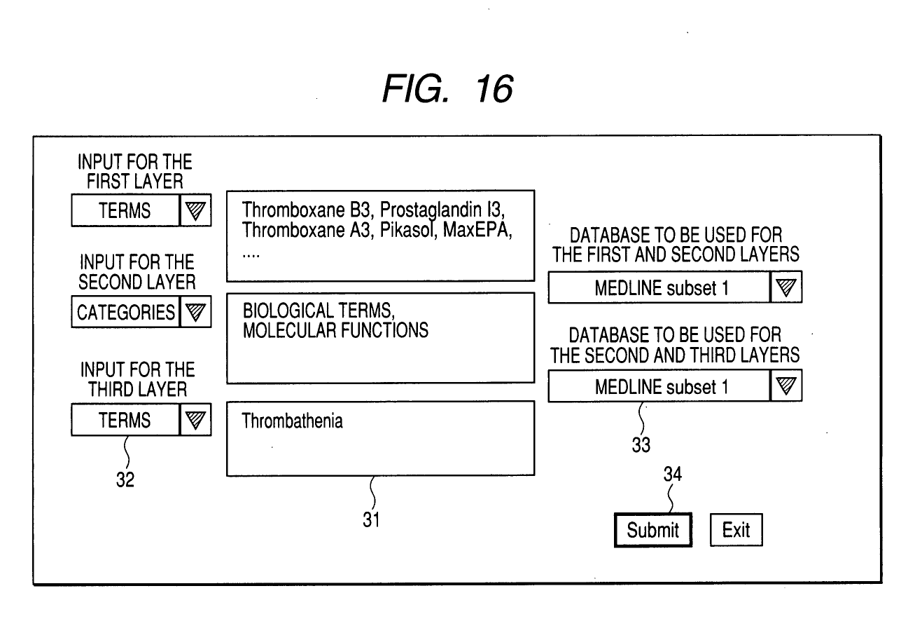

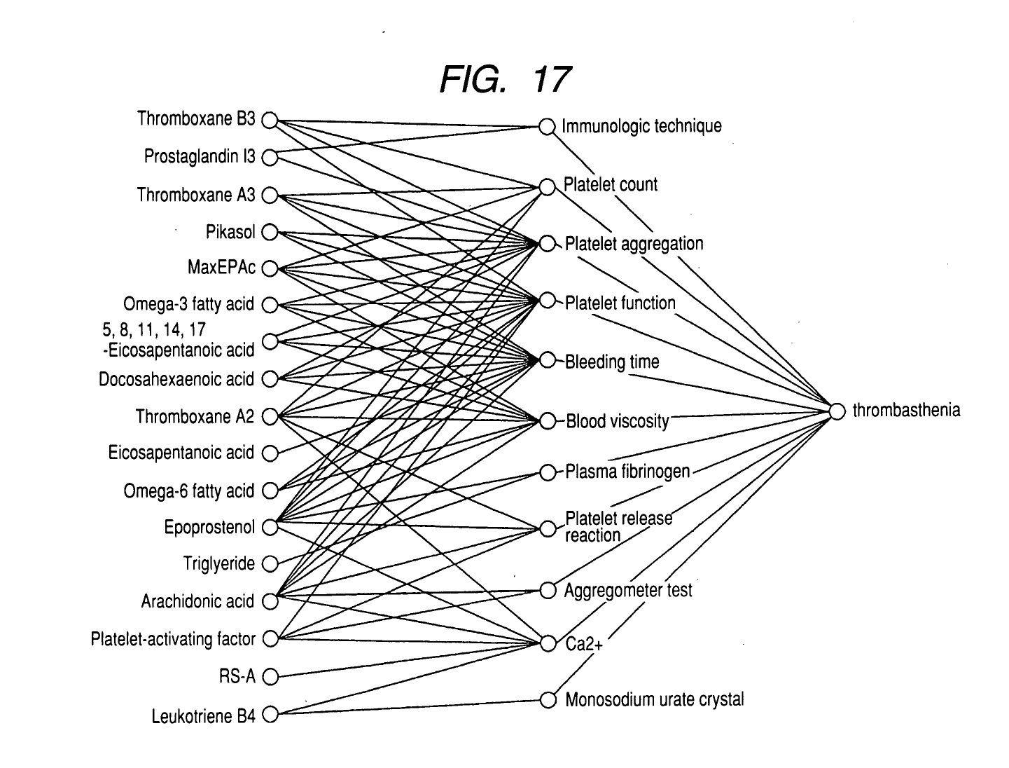

Referring to FIG. 16 and FIG. 17, an example in which the rightmost third layer includes only one term will be described below. In the input screen image supported by the data reception unit 12, as shown in FIG. 16, terms are entered for the first layer, physiological terms and molecular functions are designated as categories for the second layer, and thrombasthenia is entered as a term for the third layer. In the input screen image supported by the plotting condition reception unit 13, nothing is designated.

FIG. 17 shows a graph indicating the relationships among concepts and being created under the above conditions after the number of edge crossings is reduced according to an embodiment of the present invention. The leftmost (first) layer includes concepts concerning compounds, the intermediate (second) layer includes concepts concerning physiology and molecular functions, and the rightmost (third) layer includes a concept concerning a disease. In FIG. 17, one term is designated for the rightmost third layer. Since thrombasthenia is designated for the rightmost third layer, concepts concerning physiology and molecular functions that are unrelated to thrombasthenia are not included in the intermediate layer.

If the leftmost first layer includes data items representing degrees of gene expression, the data items are sorted in descending order of a level of variation or a significant probability of a p-value. Thereafter, the number of edge crossings is reduced. Consequently, genes whose degrees of expression have risen and genes whose degrees of expression have fallen are different from each other in terms molecular functions.

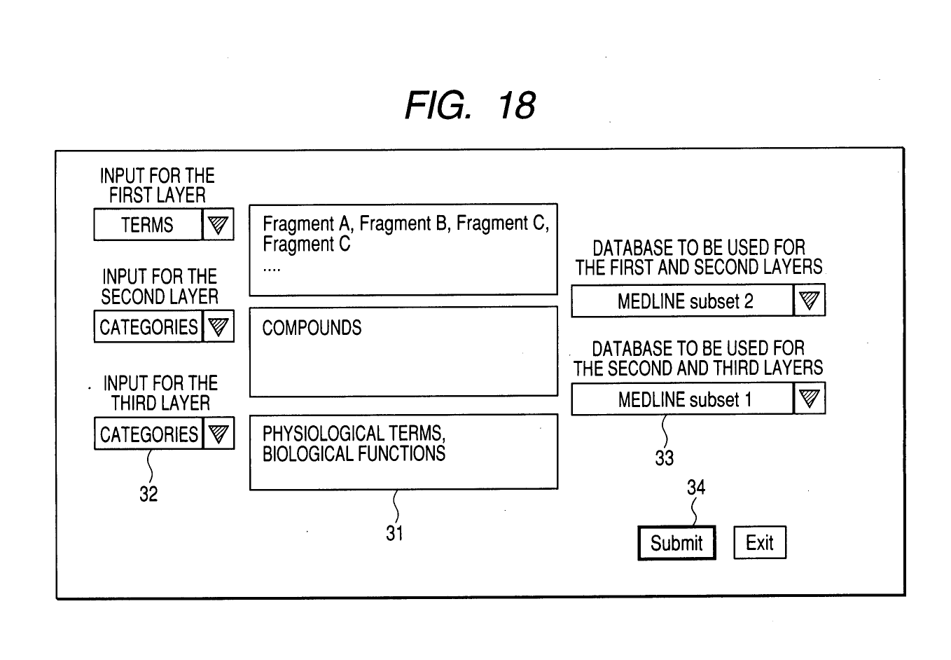

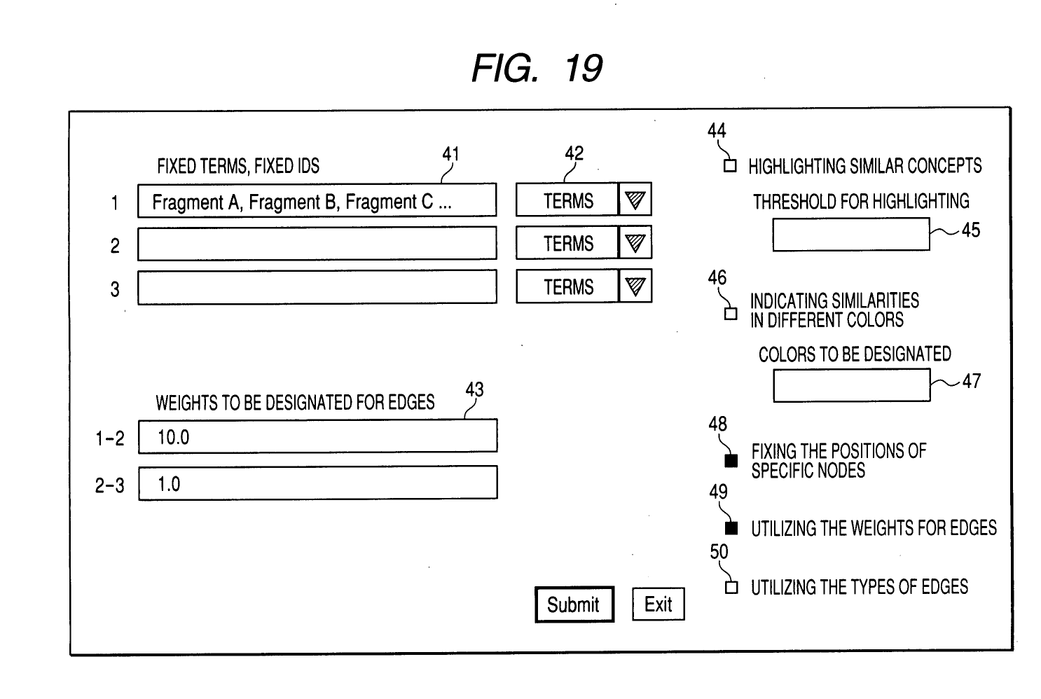

Referring to FIG. 18 to FIG. 20, a description will be made of an example in which the first layer is fixed and an emphasis is put on the relationship between the first and second layers. In the input screen image supported by the data reception unit 12, as shown in FIG. 18, terms are entered for the first layer, compounds are designated as a category for the second layer, and physiological terms and biological functions are designated as categories for the third layer. The MEDLINE Subset 2 is designated as a database to be used for the first and second layers, and the MEDLINE Subset 1 is designated as a database to be used for the second and third layers. In the input screen image supported by the plotting condition reception unit 13, as shown in FIG. 19, fragment A, fragment B, fragment C, and fragment D are entered in that order for the first layer in the fixed information input block 41. Moreover, in the weight input block 43, 10.0 is designated as a weight to be assigned to edges linking nodes in the first layer and nodes in the second layer. 1.0 is designated as a weight to be assigned to edges linking the nodes in the second layer and nodes in the third layer. The check box 49 is checked, and the check box 48 is checked.

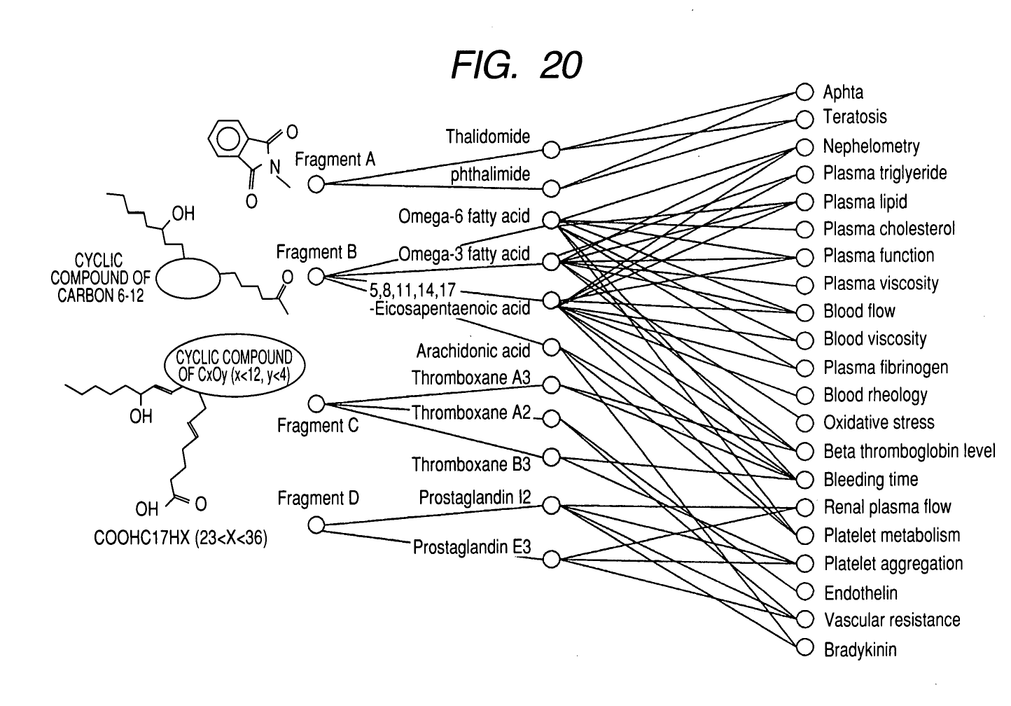

FIG. 20 shows a graph indicating the relationships among concepts and being created after the number of edge crossings is reduced according to an embodiment of the present invention. In FIG. 20, the leftmost first layer includes partial structures of a compound, the intermediate second layer includes compounds, and the rightmost third layer includes concepts concerning physiological terms and biological functions. Nodes representing the partial compound structures in the first layer are fixed. For a better understanding of the relationships between the common partial structures and the compounds, a weight to be assigned to the left edges (linking the partial structures and the concepts of compounds) is ten times higher than a weight to be assigned to the right edges (linking the compounds and the physiological concepts and biological functional concepts). The left edges exhibit no edge crossing. This clearly demonstrates what partial structures are bound to what physiological or biological functions.

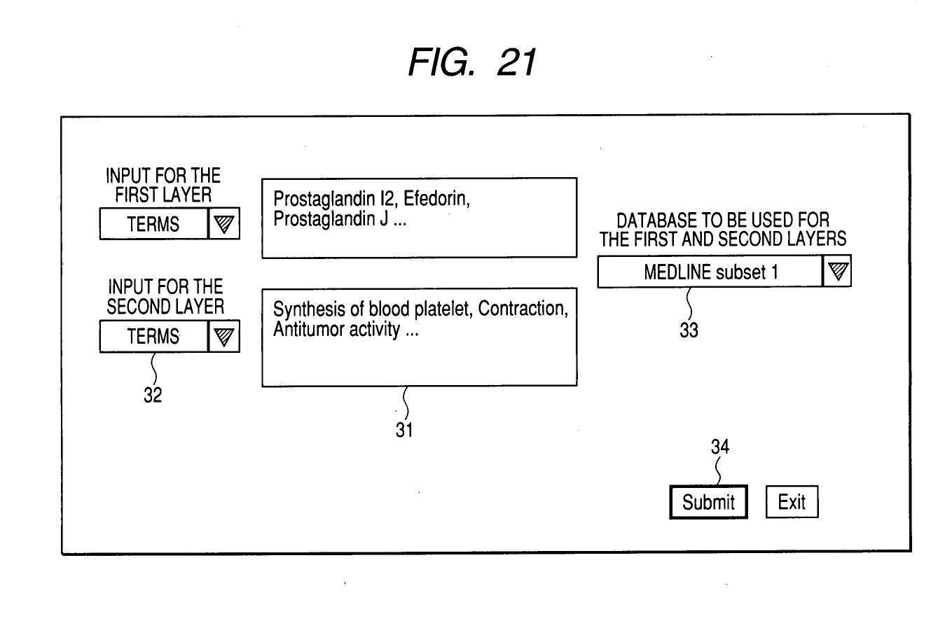

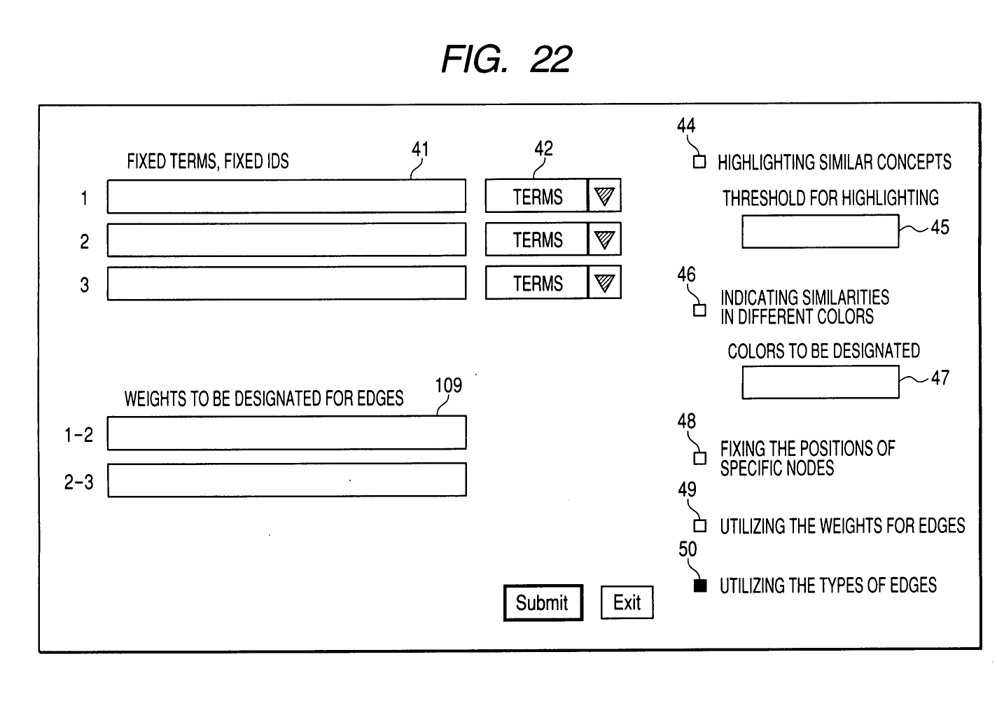

Next, an example in which types of edges are utilized will be described below. In the input screen image supported by the data reception unit 12, as shown in FIG. 21, terms are entered for the first and second layers. The MEDLINE Subset 1 is designated as a database to be used for the first and second layers. In the input screen image supported by the plotting condition reception unit 13, as shown in FIG. 22, a check box 5 for indicating whether types of edges are utilized is checked.

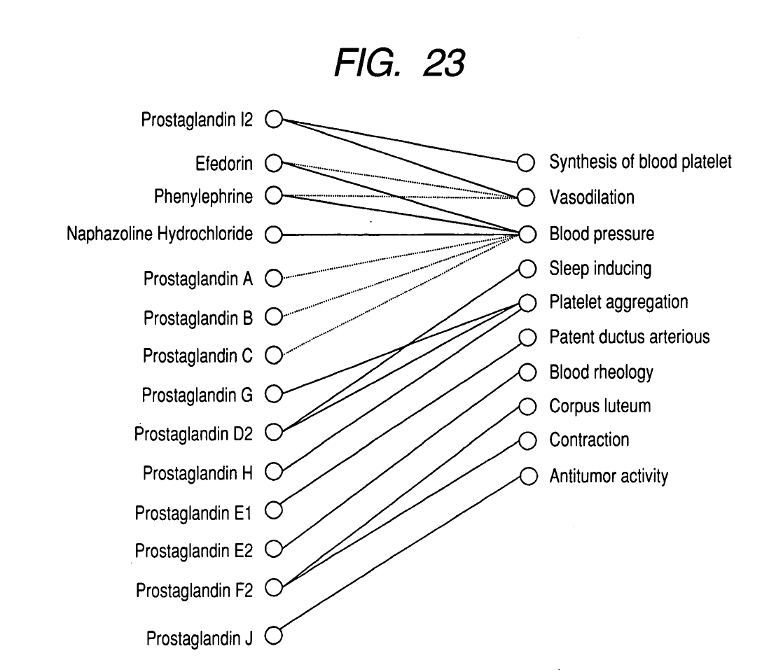

FIG. 23 is a relationship chart in which the left first layer includes compounds and the right second layer includes concepts concerning physiological actions, and in which the number of edge crossings is reduced according to an embodiment of the present invention. In FIG. 23, a rise in a degree of expression or activation is indicated with a solid line, a fall in the degree of expression or inhibition is indicated with a dot line. In this drawing, the number of pairs of adjacent edges that are of different types and that terminate at the same nodes is decreased in the course of reducing the number of edge crossings. Namely, the number of pairs of edges one of which is drawn with the solid line and the other of which is drawn with the dot line is decreased. Consequently, compounds that cause a blood pressure to rise (ephedrine, phenylpherine, and naphazoline hydrochloride) are separated from compounds that cause the blood pressure to fall (prostaglandin A, B, and C) Thus, similar concepts can be discriminated more finely. If the check box 50 shown in FIG. 22 is not checked, naphazoline hydrochloride, and prostaglandin A, B, and C are listed disorderly. The compounds that cause the blood pressure to rise will not automatically be separated from the compounds that cause it to fall.

What is claimed is:

1. A similar concept extraction system, comprising:
a data reception unit that receives, from a first input, information on concepts to be included in a plurality of layers, and, from a second input, information on databases to be used for at least two adjacent layers, and that receives information on relationships between concepts in and between adjacent layers;
a graph creation unit that creates at least one graph in which nodes represent the concepts acquired by the data reception unit, edges represent the relationships between concepts, and wherein the nodes included in the adjacent layers are linked by the edges;
a number-of-edge crossings reduction unit that modifies arrays of the nodes in and across the adjacent layers to reduce a number of edge crossings in the graph; and
a display device on which the graph is displayed.

2. The similar concept extraction system according to claim 1, wherein the first input receives the concepts as terms to be included in one of the adjacent layers.

3. The similar concept extraction system according to claim 1, wherein the first input receives categories to which the concepts to be included in the designated adjacent layer belong, and extracts the concepts that belong to the categories, from the database that is for that one of the adjacent layers, and wherein the second input adopts the extracted concepts for inclusion in that one of the adjacent layers.

4. The similar concept extraction system according to claim 1, wherein the data reception unit receives the information on relationships between the pairs of the concepts from the database which the second input block has received as the database to be used for the adjacent layers.

5. The similar concept extraction system according to claim 1, further comprising a plotting condition reception unit that receives a condition under which the number of edge crossings in the graph is reduced.

6. The similar concept extraction system according to claim 5, wherein the plotting condition reception unit receives conditions under which the edges are weighted, and the number-of-edge crossings reduction unit modifies the arrays of nodes in the respective layers in consideration of the weights to be assigned to the edges so that the sum of the weights assigned to the crossing edges is minimized.

7. The similar concept extraction system according to claim 5, wherein the plotting condition reception unit receives fixing information based on which of specific ones of the concepts in a designated one of the adjacent layers are fixed in a position, and the number-of-edge crossings reduction unit modifies the arrays of nodes in the respective layers so that the number of edge crossings in the graph will be reduced with the positions of the nodes fixed.

8. The similar concept extraction system according to claim 5, wherein the plotting condition reception unit receives information on a degree to which ones of the nodes are linked in common with the nodes in another one of the adjacent layers as a condition for highlighting nodes.

9. The similar concept extraction system according to claim 5, wherein the plotting condition reception unit receives types of the edges as a condition for reducing the number of the edge crossings, and assigns priorities according to which of the number of the crossings is eliminated.

10. The similar concept extraction system according to claim 1, further comprising at least one external database in which the information on the concepts and the relationships between pairs of concepts are stored.

11. The similar concept extraction system according to claim 1, further comprising a preprocessing unit that extracts the information on the relationships between the pairs of the concepts from at least one of external documents and external databases.

12. The similar concept extraction system according to claim 1, wherein the concepts are biological terms.

13. A similar concept extraction method comprising the steps of:
creating a graph in which a first set of concepts is regarded as a layer, the concepts included in one of the layers are represented by nodes and arrayed one-dimensionally, relationships between pairs of the concepts are represented by edges, and the nodes included in adjacent ones of the layers are linked by respective ones of the edges;
modifying the arrays of the nodes in a respective one of the layers so as to minimize a number of edge crossings in the graph; and
displaying the graph having the number of the edge crossings minimized.

14. The similar concept extraction method according to claim 13, wherein the arrays of the nodes in the respective ones of the layers are modified so that the number of the edge crossings in the graph will be minimized with positions of the nodes in a designated one of the layers fixed.

15. The similar concept extraction method according to claim 13, wherein the edges are at least one of weighted, differentiated among types, and assigned priorities, and the arrays of the nodes in the respective ones of the layers are modified in consideration of the weights, types, or priorities so that the number of edge crossings in the graph is minimized.

16. The similar concept extraction method according to claim 13, wherein, when a degree to which ones of the nodes are linked in common to others of the nodes in a same layer or another layer meets a designated condition, the linked ones of the nodes are highlighted.
